(19) United States
(12) Patent Application Publication
(10) Pub. No.: US 2011/0148574 A1
(43) Pub. Date: Jun. 23, 2011

(54) MOBILE IDENTIFICATION TRANSMITTER OF A SECURITY SYSTEM

(75) Inventors: Jörg Simon, Wulfrath (DE); Helmut Schumacher, Coesfeld (DE)

(73) Assignee: Huf Hulsbeck & Furst GmbH & Co. KG, Velbert (DE)

(21) Appl. No.: 12/996,544

(22) PCT Filed: Jun. 4, 2009
(86) PCT No.: PCT/EP2009/056904

§ 371 Date: Feb. 10, 2011

(30) Foreign Application Priority Data
Jun. 4, 2008 (DE) 10 2008 026 675.2
Aug. 14, 2008 (DE) 10 2008 037 717.1

(51) Int. Cl. G05B 19/00

(52) U.S. Cl. 340/5.61

(57) ABSTRACT

The invention relates to a mobile identification transmitter (10) of a security system for a keyless activation of a locking mechanism (43) of a motor vehicle (40), having a housing (11) in which an electronics unit (12) is disposed, having at least one transmitting and receiving unit (13), the transmitting and receiving unit (13) is in connection (42) with a connection unit in the motor vehicle, and where by means of the connection an identification test can be performed for determining the authorization of a user. According to the invention, the electronic unit (12) comprises a communication means (20) to enable a data transfer (25, 25′) to an external data device (30, 30′) only at a range of up to 10 cm.

The invention relates to a mobile identification transmitter of a security system for a keyless activation of a locking mechanism of a motor vehicle according to the preamble of claim 1, having a housing, in which an electronics unit is disposed having at least one transmitting and receiving unit that is connected to a connection unit in the motor vehicle; using the connection unit an identification test can be performed for determining the authorization of a user.

Mobile identification transmitters are used in numerous applications in motor vehicles for increasing user comfort. An authorized user can actively actuate an identification transmitter, to transmit a signal to the base station, for example to an electronics unit provided in the motor vehicle, for opening the vehicle.

For attaining a high level of user comfort, mobile identification transmitters have transmitting and receiving units that allow long distance connection to connection units in the motor vehicle. It turned out to be a disadvantage that further functions of the mobile identification transmitter are also transmitted via these long range transmitting and receiving units. This leads to the fact that security-relevant instructions can also be transmitted to the motor vehicle over a long distance. Accordingly, the motor vehicle also accepts security-relevant instructions that were sent from a long distance. Therefore, it is possible that security-relevant functions—such as deactivating an airbag—could be triggered by an unintended coincidence.

The objective of the present invention is to provide a mobile identification transmitter which overcomes the named disadvantages, in particular, to create a mobile identification transmitter with which increased security during operation can be attained.

This objective is fulfilled in an advantageous manner by a mobile identification transmitter of a security system for keyless activation of a locking mechanism of a motor vehicle with the features of claim 1. Further advantageous embodiments of the present mechanisms result from the respective dependent claims. In this context, the features mentioned in the claims and in the description can each be essential to the invention, individually or in any arbitrary combination.

The mobile identification transmitter according to the invention is distinguished by the electronics unit having a communication means for making possible a data transfer to an external data device exclusively up to a range of 10 cm.

The essence of the invention is to equip the mobile identification transmitter with a communication means. This communication means allows data transfers up to a range of less than 10 cm. Consequently, the mobile identification transmitter comprises two elements designed for transmitting and receiving information. The transmitting and receiving unit that serves to attain an authentication of the mobile identification transmitter with respect to the vehicle is integrated in the mobile identification transmitter. In addition, a communication means is integrated in the mobile identification transmitter. Using the communication means other, also safety relevant information can be exchanged with an external data device, in the scope of the data transfer. Therefore, it is conceivable, for example that the external data device is integrated in the motor vehicle, and using the communication means, for example the air bag can be activated or deactivated. For overcoming the disadvantages named above, it is essential that the range of communication is clearly limited. The range according to the invention over which data transfer is possible is limited to approximately 10 cm. If the distance between the mobile identification transmitter and the external data device is greater than 10 cm, data transfer between the communication means and the external data device is therefore no longer possible. As a consequence, incorrect operations of the mobile identification transmitter cannot lead to safety relevant unforeseen incidents. Furthermore, this feature of the mobile identification transmitter prevents unauthorized eavesdropping of the data transmitted via the data transfer. Therefore, it is not possible for an unauthorized third party to eavesdrop on information transmitted to the external data device using the communication means. Because for this purpose, the unauthorized third party would have to get within the transmission range of up to 10 cm from the communication means.

In an advantageous variant of the invention, the communication means operates according to a Near Field Communication standard. The NFC technology is a contactless, inductive connection technology. It operates in a frequency range of 13.56 Mhz and offers a maximum data transfer rate of 424 Kbits/s at a range of up to 10 centimeters. NFC technology is standardized by ISO (International Organization for Standardization) 18092, 21481 ECMA 340, 352, 356, 362 and ETSI (European Telecommunication Standards Institute) TS 102 190. NFC technology is compatible with the Smart Card Infrastructure used, based on ISO/IEC 14443A (e.g., NXP's Mifare technology), and also with Sony's FeliCa card, which are used for electronic tickets in local mass transit and for payment applications.

In a further advantageous embodiment, the communication means has a transmitting means and a receiving means. For facilitating a range of less than 10 cm for the communication means, it comprises a transmitting and receiving means. The transmitting means can preferably send out electromagnetic waves that are received by the external data device. The receiving means, in contrast, receives electromagnetic waves and further passes them to a processing unit within the communication means. The processing unit evaluates and/or displays information received in the scope of the data transfer. Likewise, the information is processed by the processing unit so that it can be transmitted by the transmitting means. In addition to NFC technology, the transmitting and receiving means can also use one of the following technologies: USB interface (Universal Serial Bus), SPI (Serial Peripheral Interface), I2C (Inter-Integrated Circuit), UART (Universal Asynchronous Receiver Transmitter) serial link, or wireless USB interface. It is critical for the named technologies that the range is, or can be, limited to 10 cm. Thus, data transfer is possible only within this range.

In a further enhancing measure of the invention, the data transfer comprises a unidirectional and/or bidirectional transmitting and/or receiving of data.

In an advantageous variant of the invention, the communication means comprises
an energy absorbing passive mode, wherein data transfer is performed by damping a received energy, and
an energy emitting active mode, wherein damping of energy emitted by the communication means leads to a data transfer to the communication means in the external data device.

In the scope of the energy emitting active mode, the transmitting means of the communication means emits a high frequency electromagnetic alternating field, which illuminates a receiving element of the external data device. An induction current arises in an antenna coil of the receiving element as soon as this comes into the range of the electromagnetic field. The current is rectified and used to charge a capacitor as a short-term storage that is used in the scope of data transfer for the current supply of the external data device. The external data device activated this way receives a command of the communication means either via the electromagnetic alternating field or a parallel connected information field. It has turned out to be particularly advantageous if these commands are modulated onto the electromagnetic alternating field that is emitted by the transmitting means. The external data device uses the induced current to operate a processing element that generates the reply to the query of the mobile identification transmitter. Then, through a field suppression in the contactless short circuit or via a reflection, the reply is modulated onto the electromagnetic field emitted by the communication means. The external data device can transmit a plurality of information in the scope of this reply. Thus, the external data device is passive and has no energy source of its own. Rather, the external data device uses the energy emitted by the communication means to perform the data transfer. In the represented example, the data transfer is bidirectional. This is due to the fact that the communication means emits a query to the external data device by modulating the electromagnetic alternating field. A reply is then transmitted on the basis of this query.

Furthermore, it is possible for the communication means to use the energy absorbing passive mode. In this case, the communication means uses an electromagnetic alternating field that is irradiated by the external data device into the transmitting means. Consequently, the behavior of the communication means and of the external data device in active mode is exchanged in comparison to their behavior in passive mode.

In a further advantageous embodiment, the communication means comprises an energy emitting transmitting mode for receiving and transmitting data. The energy emitting transmitting mode differs from the passive and active modes in that the receiving element does not use received electromagnetic waves for the purpose of forming an energy store for the data transfer. Rather, only information is generated from the electromagnetic waves received in the scope of the data transfer. In parallel to this, the transmitting means is used also only for transmitting information. The radiated electromagnetic waves are not used for the purpose of supplying an external data device with energy.

In a further measure improving the invention, the data transfer to the external data device can be performed in passive mode and/or in active mode and/or in transmitting mode.

In an advantageous variant of the invention, the communication means operates within a frequency range f that is between 10 MHz≦f≦15 MHz, in particular, within a frequency range f at 13.56 MHz.

In a further advantageous embodiment, the transmitting and receiving unit allows an information transfer to the connection unit of the motor vehicle up to a range of 300 m, preferably up to 200 m.

In a further measure improving the invention, the communication means is blocked during activation of the transmitting and receiving unit. According to the invention, when the transmitting and receiving unit is active, the communication means cannot transfer any information to the external data device in the scope of the data transfer. Here, activation means that a user of the mobile identification transmitter has transmitted an appropriate command to the transmitting and receiving unit such that this is connected to the connection unit in the motor vehicle. This activation also comprises all transmission of data by the transmitting and receiving unit to third-party facilities, for instance workshops, etc. Blocking the communication means guarantees that there is no interference between the information emitted by the transmitting and receiving unit and the data radiated by the communication means. The blocking of the communication means for this purpose can occur in several ways. For instance, the energy supply of the communication means can be interrupted during the period in which the transmitting and receiving unit is active. It is also conceivable that transmitting and/or receiving of information by means of the transmitting and receiving unit causes a processing unit of the electronics unit to generate a corresponding signal. This signal has the effect that the communication means does not accept and/or trigger any data transfer to an external data device.

In an advantageous variant of the invention, the transmitting and receiving unit is blocked during activation of the communication means. Within the scope of this variant embodiment, the transmitting and receiving unit can not establish a connection to the connection unit in the vehicle when the communication means is transferring data to an external data device. In the scope of the invention, “blocked” means it is not possible to radiate electromagnetic waves by means of the transmitting and receiving unit. This blocking can be attained using different approaches. Thus, a processing unit within the electronics unit can ensure that any type of activation command is not further transferred to the transmitting and receiving device. An appropriate computer program can run in the processing unit for this purpose. However, it is also conceivable that during activation of the communication means the energy supply to the transmitting and receiving unit is interrupted. Thus, it is guaranteed that despite a corresponding command to the transmitting and receiving unit, it cannot transmit any electromagnetic waves.

The function of the mobile identification transmitter can be expanded by the combination of NFC technology with the already present remote-control high-frequency technology. Thus, the range can be switched from near to remote according to the desired range of the function. On one hand, the mobile identification transmitter can utilize the NFC dependent range of 10 cm, and thus, exclude an unintended operating error. On the other hand, the radio link can also allow functions up to a range of several hundred meters. Thus, the intended deactivation of the airbags, for example, can be activated using the near field function. The range limitation is also important for a payment function. Data transmitted using the near field path can be transmitted to the vehicle using the radio remote control operation transmission path.

In a further advantageous embodiment of the invention, only the transmitting and receiving unit, or the communication means can be used at a time. This ensures that no interference occurs between the data transfer of the communication means and the connection of the transmitting and receiving unit. Thus, the mobile identification transmitter according to the invention can either be in contact with the connection unit in the vehicle, or can transfer data to an external data device. This variant has the advantage that data transfers, particularly to safety relevant data devices, cannot be disrupted by the transmitting and receiving unit. Rather, it requires an active triggering of the communication means that leads to a deactivation and/or blocking of the transmitting and receiving unit. Conversely, the same applies when the user of the mobile identification transmitter transmits a control command to the security system of the locking mechanism of the motor vehicle. In this case, too, it is guaranteed that the communication means cannot start and/or perform data transfer.

In a further advantageous embodiment, the mobile identification transmitter comprises a switch element by means of which the transmitting and receiving unit or the communication means can be alternatively activated or blocked. The switch element ensures that at any given time only the transmitting and receiving unit or the communication means are in operation. There is a plurality of possibilities for the embodiment of the switch element. For instance, the switch element can be a computer program, which runs on the processing unit of the electronics unit. If the transmitting and receiving unit is actuated, this leads to an actuation of a switching element, that is, the computer program. This computer program can block the communication means and/or interrupt a current supply to the communication means. Alternatively, it is also possible that the switch element is a manually operated switch that must be activated by the user in order to operate the transmitting and receiving unit or the communication means. Thus, the connection to the motor vehicle or the data transfer to the external data device can only be established when the user has actuated the switching element in advance. In a further measure improving the invention, the switch element is disposed in the electronics unit and/or in the housing and/or on the housing.

In an advantageous variant of the invention, the mobile identification transmitter comprises a display, wherein in particular, the data transfer and/or information regarding the data transfer can be displayed by means of the display.

In a further advantageous embodiment, the display uses at least one of the following means: a light emitting diode (LED), an organic light emitting diode (OLED), a liquid crystal display (LCD), a plasma display, a cathode ray tube, a Surface Conduction Electron Emitter Display (SED), or a field emission display (FED).

In a further measure improving the invention, the electronics unit and/or the transmitting and receiving unit and/or the communication means comprises at least one of the following technologies: wireless LAN (IEEE 802.11), FireWire (IEEE 1394), USB (Universal Serial Bus), HDMI (High Definition Multimedia Interface), IrDA (Infrared Data Association), Bluetooth, Unilink, ATA/ATAPI (Advanced Technology Attachment with Packet Interface), IEEE 488, IEEE 1284, bidirectional radio link, Near Field Communication (NFC), inductive transmission, SPI, I2C, UART serial link or wireless USB interface.

In an advantageous variant of the invention, a data connection to the Internet can be established by means of the communication means. According to the invention, a plurality of information can be sent or received from an external data device within the scope of the data transfer. Thus, the communication means can be used, for example, to transmit authentication information for a payment device. The payment device can serve, e.g., to issue a ticket for a local mass transit means. Therefore, a user of the mobile identification transmitter can approach the immediate proximity of the issuing payment device, trigger an appropriate activation, and thereby purchase a ticket. It is also conceivable that security relevant systems, for instance switching the airbag or an ESP on or off, are triggered by the data transfer. Additional possible functions that can be implemented using the communication means are:
transmitting stored data (vehicle data, such as, tank capacity, number of kilometers driven, state of closure, loading condition, weight, maintenance data, oil level, tire pressure, warning displays, state of the lights, etc.) from a mobile identification transmitter according to the invention without a display to a device having a display (e.g., mobile radio device, PDA, navigation device, vehicle radio)
transmitting setting data to the vehicle (e.g., seat positions, mirror positions, speed limits, performance, etc.)
activating a building access system (house door, garage door)
payment function at parking meters, charging stations for electric vehicles, automated fuel pumps and/or gas stations
transmitting MP3 music data from an NFC device (e.g., cellular phone, MP3 player) to a vehicle infotainment device,
activating a parking lot access system, locking a glove compartment or a trunk, and
a GPS data transfer from the vehicle to the mobile identification transmitter and also to a GPS cellular phone.

In the scope of a further variant embodiment it is possible that position information from a satellite supported navigation system, for instance GPS (global positioning system), is transmitted to the mobile identification transmitter using the communication means. There, it is possible to store the position information and possibly display it using the display. This property has proven to be particularly advantageous if the location of the motor vehicle is to be transmitted. To ensure this function, the mobile identification transmitter is brought close to a GPS data device, such as is integrated in a motor vehicle, so that the position information can be transmitted within the scope of the data transfer using the communication means. Along with the described property, the mobile identification transmitter can also receive position information from a second GPS data device that is not integrated in the vehicle. Thus, a GPS system can be installed in, for instance, a mobile telephone. Data exchange with the mobile telephone is possible using the described communication means according to the invention. In the scope of this data exchange, GPS position information from the mobile telephone can be transmitted to the mobile identification transmitter. By comparing the actual location transmitted with the mobile telephone and the location of the motor vehicle, the user of the mobile identification transmitter can be guided to the motor vehicle. This makes locating the motor vehicle at any location, fast and easy.

Further advantages, features and details of the invention result from the following detailed description in which embodiments of the invention are described in detail with reference to the drawings. In this context, the features mentioned in the claims and in the description are each essential to the invention, individually or in any arbitrary combination. They show:

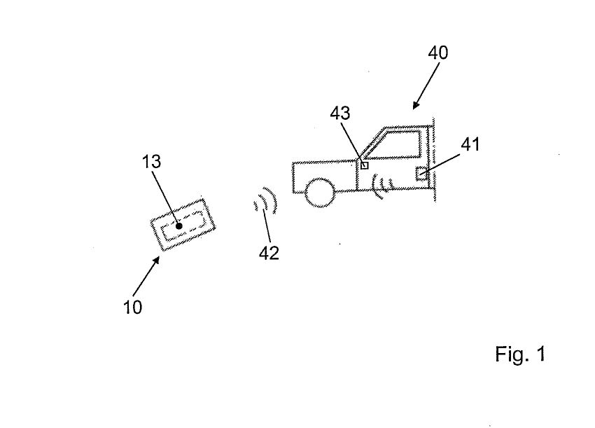

FIG. 1 a schematic view of the security system according to the invention having a mobile identification transmitter and a locking mechanism of a motor vehicle,

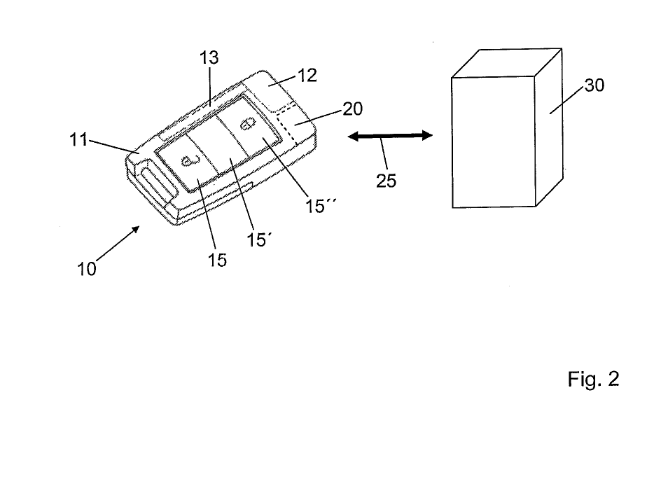

FIG. 2 the mobile identification transmitter according to the invention in a data transfer to an external data device,

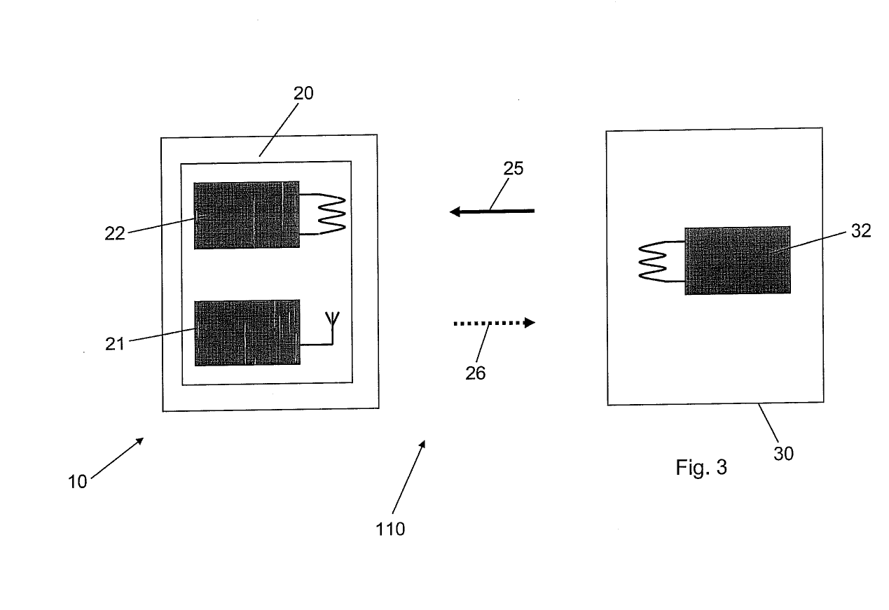

FIG. 3 a further variant embodiment of the data transfer between the mobile identification transmitter and the external data device,

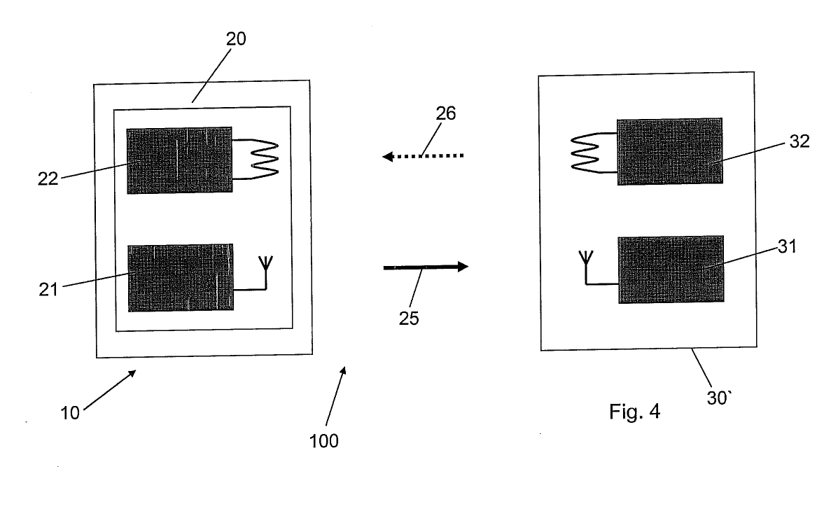

FIG. 4 a further variant embodiment of the data transfer between the mobile identification transmitter and the external data device, and

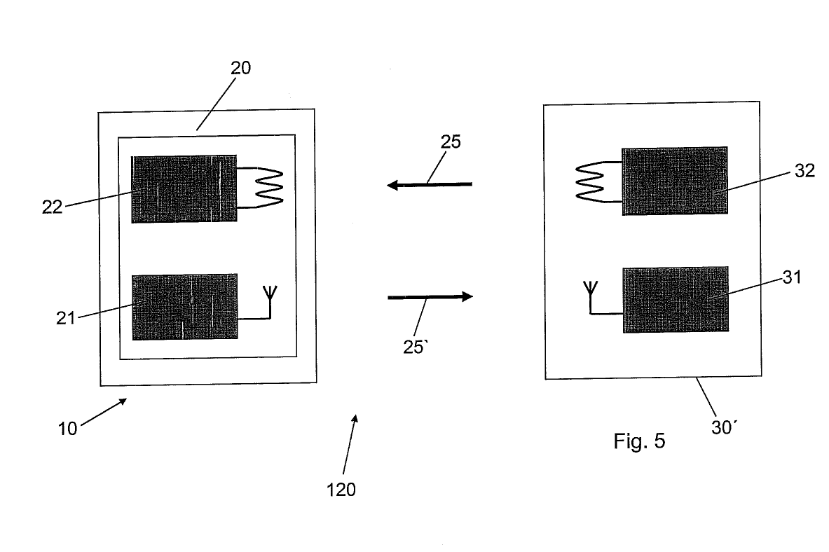

FIG. 5 a further variant embodiment of the data transfer between the mobile identification transmitter and the external data device.

FIG. 1 shows a mobile identification transmitter 10 of a security system for keyless activation of a locking mechanism 43 of a motor vehicle 40. The identification transmitter 10 is implemented having a housing in which an electronics unit 12 is disposed having a transmitting and receiving unit 13. Using the transmitting and receiving unit 13, the mobile identification transmitter 10 can establish a connection 42, in the following also called communication, to a connection unit 41 in a vehicle. In the course of the communication 42, security relevant information is exchanged for authenticating the mobile identification transmitter 10. In the scope of the connection 42, codes and/or keys, in particular, can be transmitted unidirectionally and/or bidirectionally. The aim is for the motor vehicle 40 to check the authorization of the mobile identification transmitter 10. As soon as it has been determined that the mobile identification transmitter 10 is authorized to initiate locking and/or unlocking the motor vehicle, a corresponding signal is transmitted to the locking mechanism 43, in order to initiate an opening or closing of the motor vehicle.

FIG. 2 shows a mobile identification transmitter 10 configured according to the invention. The mobile identification transmitter 10 has a housing 11. An electronics unit 12 is integrated within the housing 11. The electronics unit 12 monitors the information controlled using the mobile identification transmitter 10. To ensure this function it has proven advantageous for the mobile identification transmitter 10 to comprise a data storage. This data storage can be integrated in the electronics unit 12. For assuring an appropriate supply of energy, the mobile identification transmitter 10 also comprises an energy storage device. Here, a rechargeable energy storage device has proven advantageous. Additionally, a processing unit is integrated in the electronics unit 12. The processing unit can execute a computer program. The processing unit is preferably an FPGA (Field Programmable Gate Array), a microcontroller or a differently designed integrated circuit.

As indicated in FIG. 2, the transmitting and receiving unit 13 is a part of the electronics unit 12. The sending and transmitting unit serves to establish the communication 42 with the motor vehicle 40. In the illustrated example embodiment, the transmitting and receiving unit 13 is disposed at one of the side surfaces of the housing 11. For overcoming the disadvantages listed above, the electronics unit 12 comprises a communication means 20. This is also disposed in a housing 11 of the mobile identification transmitter 10. The communication means 20 allows a data transfer 25 to an external data device 30, only in a range of up to 10 cm. To enable this data transfer 25, the communication means 20 has a transmitting means 21 and a receiving means 22.

To initiate a data transfer 25, it has proven advantageous that the mobile identification transmitter 10 comprises an appropriately designed actuating element. In the represented example embodiment, three actuating elements 15, 15′, 15″ are integrated in the housing 11 of the mobile identification transmitter 10. The actuating elements 15, 15″ initiate keyless activation of the locking mechanism 43 of the motor vehicle 40. Appropriately embellished pictograms clarify the function. The actuating element 15 can initiate unlocking the locking mechanism 43. A corresponding command is generated by the electronics unit 12, and is transmitted via the transmitting and sending unit 13 to the motor vehicle 40. In contrast, if the user wishes to lock a motor vehicle 40, actuating element 15″ is actuated. If the user is in proximity to the external data device 30, a data transfer 25 is initiated by actuating the actuating element 15′. Additionally, a display can also be integrated into the housing 11 of the mobile identification transmitter 10. This is not represented in the example embodiment shown in FIG. 2. The display can be used for visually displaying data that is transmitted to and/or from the mobile identification transmitter 10. It has been shown to be advantageous that the display is a liquid crystal display and/or a plasma display.

FIG. 3 shows a schematic representation of the mobile identification transmitter 10. The communication means 20 is disposed within the mobile identification transmitter 10. This communication means 20 comprises a transmitting means 21 and a receiving means 22. The external data device 30 is disposed in proximity, thus, within a range of less than 10 cm. The external data device can be, for instance, an information chip, such as an RFID chip. An external data device 30 equipped in this manner can store information such as serial numbers, etc. According to the invention the communication means 20 can be used in different modes. FIG. 3 displays an energy emitting active mode 110. In this mode, the sending means 21 of the communication means 20 generates a high frequency electromagnetic alternating field that illuminates the receiving element 32 of the external data device 30. An induction current arises in an antenna coil of the receiving element 32. This induction current can be used to operate a processing element within the external data device. A processing element activated in this manner can receive commands and/or information from the communication means 20. These commands and/or information are processed in the processing element, which generates a reply from it. This reply is transmitted in the scope of a data transfer 25 from the receiving element 32 to the communication means 20. The receiving means 22 is used here as a receiver. The reply is generated in that the receiving element 32 weakens the electromagnetic alternating field radiated by the transmitting means 21 in the scope of an energy transfer 26. This weakening is distinctive and contains the reply of the external data device 30. In the scope of the active mode 110, the communication means 20 transmits the energy that the external data device 30 uses to establish a data transfer 25. The active mode 110 has proven to be particularly advantageous when predetermined information must be read out using the communication means 20. In this case, the data device 30 is frequently a non-active system whose task is to make available information that was previously determined, for instance serial numbers, for read out.

FIG. 4 shows a further variant embodiment of the identification transmitter 10 according to the invention. Here, the identification transmitter 10 is operated in a passive mode 100. This passive mode 100 is distinguished by an energy transfer 26 from the external data device 30′. Compared to the active mode 110 shown in FIG. 3, the mobile identification transmitter 10 does not transfer the energy, but rather receives energy from the external data device 30′. Consequently, a transmitting element 31 must be disposed in the external data device 30′ that emits a high-frequency electromagnetic alternating field to make the energy transfer 26 possible. According to the invention, the communication means 20 recognizes and utilizes this energy transfer 26. Consequently, the communication means 20 switches into passive mode 100. In this mode, the receiving means 22 modulates the field strength of the high-frequency electromagnetic alternating field radiated by the transmitting element 31 in the scope of the energy transfer 26. This damping of the electromagnetic field, described already in the scope of the active mode 110, is used in a passive mode 100 to read out information from the communication means 20.

Thus, the passive mode 100 and the active mode 110 differ in the direction of the energy transfer 26. If this transfer takes place from the communication means 20 to an external device 30, then they are operating in the active mode 110. In contrast, if the external data device 30′ radiates energy to the communication means 20, this is using passive mode 100.

In addition to the two described modes, in a third mode, the so-called transmitting mode 120, a data transfer 25, 25′ takes place between the communication means 20 and an external data device 30′. FIG. 5 shows this transmitting mode 120. In the scope of the transmitting mode 120, no energy transfer 26 takes place, insofar as the respectively transmitted electromagnetic waves are used exclusively for the information flow. Thus, the transmitting means 21 of the communication means 20 transmits an exemplary amplitude modulated or frequency modulated electromagnetic wave 25′ to the transmitting element 31 of the external data device 30′. A processing element within the external data device 30′ can evaluate the received information, and can provide requested data and/or information for a transmission to the communication means 20. For the transmission, the transmitting element 31 is used, which in turn modulates electromagnetic waves and transmits these in the scope of the data transfer 25 to the communication means 20. The receiving means 22 of the communication means 20 receives the data transmitted in this manner within the scope of the data transfer 25, and makes it available to the processing unit within the mobile identification transmitter 10.

Thus, the mobile identification transmitter 10 according to the invention comprises three modes: the active, passive and transmitting mode. According to the invention the mobile identification transmitter 10 is implemented such that the communication means 20 can at any time be activated in one of three modes. In one variant, no selection by the user is required. Rather, the communication means 20 is designed such that it responds to external conditions. Thus, the active mode 110 can be switched on at approximately isochronous intervals, and the communication element 20 can perform an energy transfer 26. This can occur regardless of whether an external data device 30, 30′ is disposed at a distance of less than 10 cm at the mobile identification transmitter 10. In another variant, it is also possible that the actuating element 15′ must be actuated in order to trigger the active mode 110 with the energy transfer 26. The three modes allow the communication means 20, and with it the mobile identification transmitter 10, to communicate with a plurality of differently configured external data devices 30, 30′. It is thereby guaranteed that the mobile identification transmitter 10 can be used for a plurality of applications.

In a further advantageous variant embodiment, the mobile identification transmitter 10 can either perform a data transfer 25, 25′, or the communication 42, with the motor vehicle 40. This is intended to prevent interference arising between the two electromagnetic signals. It has proven to be advantageous that during an activation of the transmitting and receiving unit 13 the communication means is blocked, and during an activation of the communication means the transmitting and receiving unit 13 are blocked. If, for example, a vehicle user actuates the actuating element 15′ of the mobile identification transmitter 10, shown in FIG. 2, this can lead to an activation of the communication means 20. If an external data device 30 is located within a range of up to 10 cm, the data transfer 25 takes place. If the vehicle user were also to press the actuating element 15, 15″ at this moment, a computer program within the processing unit of the mobile identification transmitter 10 could prevent a communication 42 from being established to the vehicle 40. For this purpose, the energy supply of the transmitting and receiving unit 13 could be interrupted, for example. In contrast, if the vehicle owner wishes to authenticate himself to his motor vehicle, and for this purpose actuates one of the two actuating elements 15, 15″, this would result in a communication 42 to the vehicle 40. During this time it would not be possible to establish a data transfer 25 to the external data device 30. This variant shows an increased security for the user because no interference can occur between the data transfer 25 and the communication 42.

The identification transmitter 10 according to the invention allows a data transfer 25 within a close range of up to 10 cm. This leads to a plurality of advantages. Thus, eavesdropping of the data transmitted within the scope of the data transfer 25 is nearly impossible. Furthermore, it requires the deliberate activation of the data transfer 25, which cannot occur by chance. Moreover, the mobile identification transmitter 10 must always be brought within the receiving range of the external data device 30 that is not more than 10 cm.

### LIST OF REFERENCE CHARACTERS

10 Mobile identification transmitter
11 Housing
12 Electronics unit
13 Transmitting and receiving unit
15,15′,15″ Actuating element
20 Communication means
21 Transmitting means
22 Receiving means
25,25′ Data transfer
26 Energy transfer
30, 30′ External data device
31 Transmitting element
32 Receiving element
40 Motor vehicle
41 Connection unit
42 Connection, communication
43 Locking mechanism
100 Passive mode
110 Active mode
120 Transmitting mode

1. A mobile identification transmitter of a security system for keyless activation of a locking mechanism of a motor vehicle, comprising
a housing, in which an electronics unit is disposed having at least one transmitting and receiving unit,
in which the transmitting and receiving unit has a connection with a connection unit in the motor vehicle, by means of which connection an identification test for determining the authorization of the user can be performed,
wherein
the electronics unit comprises a communication means
to allow a data transfer to an external data device only in a range of up to 10 cm.

2. The mobile identification transmitter according to claim 1, wherein
the communication means operates according to an NFC standard.

3. The mobile identification transmitter according to claim 1, wherein
the communication means comprises a transmitting means and a receiving means.

4. The mobile identification transmitter according to claim 1, wherein
the data transfer comprises at least one of a unidirectional and bidirectional receiving and transmitting of data.

5. The mobile identification transmitter according to claim 1, wherein
the communication means comprises
an energy absorbing passive mode, wherein data transfer can be performed by damping a received energy, and
an energy emitting active mode, wherein damping of energy emitted by the communication means in the external data device leads to a data transfer to the communication means.

6. The mobile identification transmitter according to claim 1, wherein
the communication means comprises an energy emitting transmitting mode for receiving and sending data.

7. The mobile identification transmitter according to claim 5, wherein
the data transfer to the external data device can be performed in at least one of the passive mode and the active mode and the transmitting mode.

8. The mobile identification transmitter according to claim 5, wherein
the communication means operates within a frequency range f which lies between 10 MHz≦f≦15 MHz, and in particular, that the communication means operates within a frequency range fat 13.56 MHz.

9. The mobile identification transmitter according to claim 5, wherein
the transmitting and receiving unit allows an information transfer to the connection unit at the motor vehicle up to a range of 300 m.

10. The mobile identification transmitter according to claim 5, wherein
the communication means is blocked during an activation of the transmitting and receiving unit.

11. The mobile identification transmitter according to claim 5, wherein
the transmitting and receiving unit is blocked during an activation of communication means.

12. The mobile identification transmitter according to claim 5, wherein
the mobile identification transmitter comprises a switch element, wherein by means of the switch element the transmitting and receiving unit or the communication means can be alternatively activated or blocked.

13. The mobile identification transmitter according to claim 5, wherein
the switching element is disposed in at least one of the electronics unit, in the housing and at the housing.

14. The mobile identification transmitter according to claim 5, wherein
the mobile identification transmitter comprises a display wherein at least one of, in particular, the data transfer and information related to the data transfer can be displayed by means of the display.

15. The mobile identification transmitter according to claim 14, wherein
the display further comprises at least one of: a light emitting diode (LED), an organic light emitting diode (OLED), a liquid crystal display (LCD), a plasma display, a cathode ray tube, a Surface Conduction Electron Emitter Display (SED), and a field emission display (FED).

16. The mobile identification transmitter according to claim 14, wherein
at least one of the electronics unit the transmitting and receiving unit and the communication means further comprise at least one of the following technologies: wireless LAN (IEEE 802.11), FireWire (IEEE 1394), USB (Universal Serial Bus), IrDA (Infrared Data Association), Bluetooth, Unilink, bidirectional radio link, Near Field Communication (NFC), inductive transmission, SPI, I2C, UART serial link or wireless USB interface.

17. The mobile identification transmitter according to claim 14, wherein
a data connection to the Internet can be established by means of the communication means.
